(19) United States
(12) Patent Application Publication
(10) Pub. No.: US 2025/0225847 A1
(43) Pub. Date: Jul. 10, 2025

(54) EVACUATION INFORMATION GENERATION SYSTEM, EVACUATION INFORMATION GENERATION DEVICE, AUTONOMOUS TRAVELING DEVICE, EVACUATION INFORMATION GENERATION METHOD

(71) Applicant: DENSO CORPORATION, Kariya-city (JP)

(72) Inventors: MASAZUMI KATOH, Kariya-city (JP); YUKI KATO, Kariya-city (JP)

(21) Appl. No.: 19/095,614

(22) Filed: Mar. 31, 2025

Related U.S. Application Data
(63) Continuation of application No. PCT/JP2023/033208, filed on Sep. 12, 2023.

(30) Foreign Application Priority Data
Oct. 3, 2022 (JP) 2022-159744

(51) Int. Cl. G08B 7/06; G05D 1/246; G05D 1/617; G05D 1/69; G05D 105/55; G05D 105/70; G05D 105/80; G05D 107/60; G05D 109/10; G05D 111/30

(52) U.S. Cl. CPC G08B 7/066; G05D 1/246; G05D 1/617; G05D 1/69; G05D 2105/55; G05D 2105/70; G05D 2105/87; G05D 2107/60; G05D 2109/10; G05D 2111/30

(57) ABSTRACT

An evacuation information generation system, an evacuation information generation device, an autonomous traveling device, or an evacuation information generation method is used for generating evacuation information of a traveling area of an autonomous traveling device, acquires observation information obtained by observation by the autonomous traveling device that searches for the traveling area where a hazard is estimated to occur; and outputs the evacuation information as a hazard map or evacuation route data.

### CROSS REFERENCE TO RELATED APPLICATIONS

The present application is a continuation application of International Patent Application No. PCT/JP2023/033208 filed on Sep. 12, 2023, which designated the U.S. and claims the benefit of priority from Japanese Patent Application No. 2022-159744 filed on Oct. 3, 2022. The entire disclosures of all of the above applications are incorporated herein by reference.

### TECHNICAL FIELD

The present disclosure relates to an evacuation information generation technology in a traveling area of an autonomous traveling device.

### BACKGROUND

In a comparative example, a system guides a guided person from an interior of a building to the outdoors when an event occurs. When the event occurs, the system sets an evacuation guidance route from the guided person's current position to the exit of the building.

### SUMMARY

An evacuation information generation system, an evacuation information generation device, an autonomous traveling device, or an evacuation information generation method is used for generating evacuation information of a traveling area of an autonomous traveling device, acquires observation information obtained by observation by the autonomous traveling device that searches for the traveling area where a hazard is estimated to occur; and outputs the evacuation information as a hazard map or evacuation route data.

### BRIEF DESCRIPTION OF THE DRAWINGS

FIG. 1 is a block diagram showing an overall configuration according to an embodiment.

FIG. 2 is a schematic diagram showing a traveling environment of a host vehicle according to the embodiment.

FIG. 3 is a block diagram showing a functional configuration of an autonomous traveling device according to the embodiment.

FIG. 4 is a block diagram showing a functional configuration of the evacuation information generation system according to the embodiment.

FIG. 5 is a flowchart showing a flow executed by an information processing device according to the embodiment.

FIG. 6 is a flowchart showing a flow in an area search mode executed by the information processing device according to the embodiment.

FIG. 7 is a flowchart showing a flow in a disruption device search mode executed by the information processing device according to the embodiment.

FIG. 8 is a flowchart showing a flow executed by a server device according to the embodiment.

FIG. 9 is an example of hazard levels according to observation information acquired by the area search mode.

FIG. 10 is an example of the hazard level according to the observation information acquired by the disruption device search mode.

FIG. 11 is a diagram showing an example of a hazard map.

### DETAILED DESCRIPTION

In the comparative example, the evacuation guidance route is set based on the current position of the guided person and the exit position of the building, and does not take into account whether the guidance route is actually passable. Therefore, the evacuation guidance route may become impassable due to a disaster or other hazard, or the effective evacuation guidance route cannot be established.

One example of the present disclosure provides an evacuation information generation system capable of generating effective evacuation information. Another example of the present disclosure provides an evacuation information generation device capable of generating effective evacuation information. Further, another example of the present disclosure provides an autonomous traveling device capable of generating effective evacuation information. Furthermore, another example of the present disclosure provides an evacuation information generation method capable of generating effective evacuation information. Furthermore, another example of the present disclosure provides an evacuation information generation program capable of generating effective evacuation information.

According to a first example embodiment of the present disclosure, an evacuation information generation system for generating evacuation information of a traveling area of an autonomous traveling device includes a processor configured to: acquire observation information obtained by observation and search of the traveling area where a hazard is estimated to occur using the autonomous traveling device; and output the evacuation information as a hazard map that represents a hazard level for each location in the traveling area according to the observation information.

According to a second example embodiment of the present disclosure, an evacuation information generation device is installable in an autonomous traveling device or a remote center and used for generating evacuation information of a traveling area of the autonomous traveling device, and includes a processor configured to: acquire observation information obtained by observation and search of the traveling area where a hazard is estimated to occur using the autonomous traveling device; and output the evacuation information as a hazard map that represents a hazard level for each location in the traveling area according to the observation information.

According to a third example embodiment of the present disclosure, an autonomous traveling device autonomously traveling in a traveling area includes a processor configured to: acquire observation information obtained by observation and search of the traveling area where a hazard is estimated to occur using the autonomous traveling device; and output the evacuation information as a hazard map that represents a hazard level for each location in the traveling area according to the observation information.

According to a fourth example embodiment of the present disclosure, an evacuation information generation method is executed by a processor for generating evacuation information of a traveling area for an autonomous traveling device, and includes: acquiring observation information obtained by observation and search of the traveling area where a hazard is estimated to occur using the autonomous traveling device; and outputting the evacuation information as a hazard map that represents a hazard level for each location in the traveling area according to the observation information.

According to a fifth example embodiment of the present disclosure, a non-transitory computer-readable storage medium stores an evacuation information generation program comprising instructions executed by a processor for generating evacuation information of a traveling area for an autonomous traveling device, and the program causes the processor to: acquire observation information obtained by observation and search of the traveling area where a hazard is estimated to occur using the autonomous traveling device; and output the evacuation information as a hazard map that represents a hazard level for each location in the traveling area according to the observation information.

According to these first to fifth example embodiments, the hazard map is output according to the observation information by the autonomous traveling device, the information being related to the traveling area where the hazard is estimated to occur. Therefore, the hazard map for each location can reflect the actual observation information related to the location. Accordingly, it is possible to generate valid evacuation information.

According to a sixth example embodiment of the present disclosure, an evacuation information generation system for generating evacuation information of a traveling area of an autonomous traveling device includes a processor configured to: acquire observation information obtained by observation and search of the traveling area where a hazard is estimated to occur using the autonomous traveling device; and output the evacuation information as evacuation route data within the traveling area according to the observation information.

According to a seventh example embodiment of the present disclosure, an evacuation information generation device is installable in an autonomous traveling device or a remote center and used for generating evacuation information of a traveling area of the autonomous traveling device, and includes a processor configured to: acquire observation information obtained by observation and search of the traveling area where a hazard is estimated to occur using the autonomous traveling device; and output the evacuation information as evacuation route data within the traveling area according to the observation information.

According to an eighth example embodiment of the present disclosure, an autonomous traveling device autonomously traveling in a traveling area includes a processor configured to: acquire observation information obtained by observation and search of the traveling area where a hazard is estimated to occur using the autonomous traveling device; and output the evacuation information as evacuation route data within the traveling area according to the observation information.

According to a ninth example embodiment of the present disclosure, an evacuation information generation method is executed by a processor for generating evacuation information of a traveling area for an autonomous traveling device, and includes: acquiring observation information obtained by observation and search of the traveling area where a hazard is estimated to occur using the autonomous traveling device; and outputting the evacuation information as evacuation route data within the traveling area according to the observation information.

According to a tenth example embodiment of the present disclosure, a non-transitory computer-readable storage medium stores an evacuation information generation program comprising instructions executed by a processor for generating evacuation information of a traveling area for an autonomous traveling device, and the program causes the processor to: acquire observation information obtained by observation and search of the traveling area where a hazard is estimated to occur using the autonomous traveling device; and output the evacuation information as evacuation route data within the traveling area according to the observation information.

According to these sixth to tenth example embodiments, the route evacuation data is output according to the observation information by the autonomous traveling device, the information being related to the traveling area where the hazard is estimated to occur. Therefore, actual observation information can be reflected in the evacuation route data within the traveling area. Accordingly, it is possible to generate valid evacuation information.

Hereinafter, an embodiment of the present disclosure will be described with reference to the drawings.

### First Embodiment

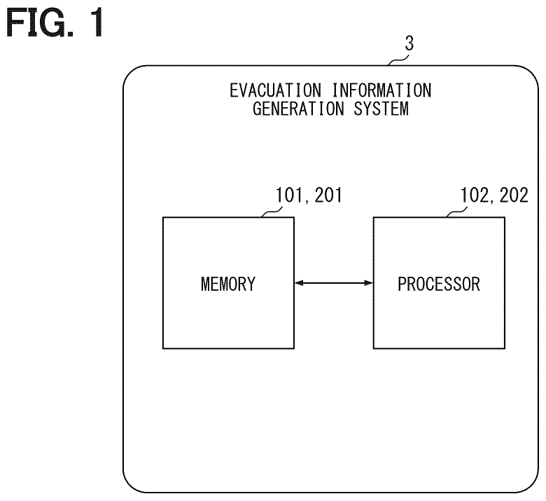

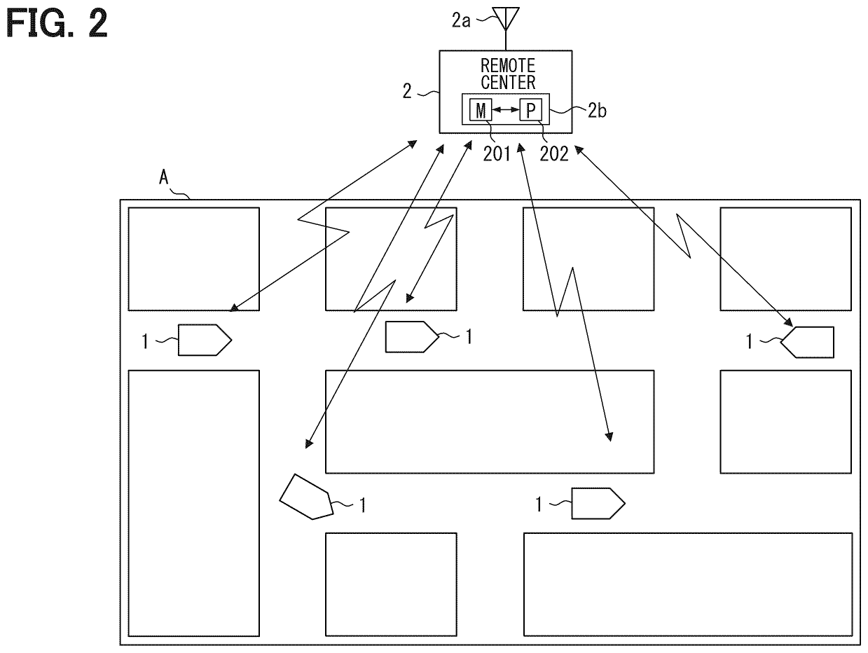

An evacuation information generation system 3 of a first embodiment shown in FIG. 1 generates evacuation information related to a traveling area A of an autonomous traveling device 1 shown in FIG. 2. The evacuation information generation system 3 includes, for example, multiple autonomous traveling devices 1 and a server device 2b provided at a remote center 2 that manages the operation of the autonomous traveling devices 1.

The autonomous traveling device 1 is an autonomous robot that can travel autonomously in any direction, forward, backward, left, or right. The autonomous traveling device 1 may be a logistics robot that autonomously travels through facilities such as hospitals and warehouses as the traveling area A and transports packages in a normal state. Alternatively, the autonomous traveling device 1 may be a delivery robot that autonomously travels along the road as traveling area A in the normal state to transport packages to delivery destinations. Alternatively, the autonomous traveling device 1 may be an information collection robot that collects specific information by patrolling the traveling area A, such as facilities or roads in the normal state.

The autonomous traveling device 1 provides the above-described services in the traveling area A in the normal state, and collects observation information necessary for the evacuation information generation process in the evacuation information generation system 3 in the traveling area A when a hazard occurs. Here, the hazard is an event that can cause damage to the traveling area A. The hazard can also be an event that requires the evacuation of users in the traveling area A. For example, the hazards include disaster events such as earthquakes and fires. The traveling area A where the hazard occurred may be referred to as the hazard area.

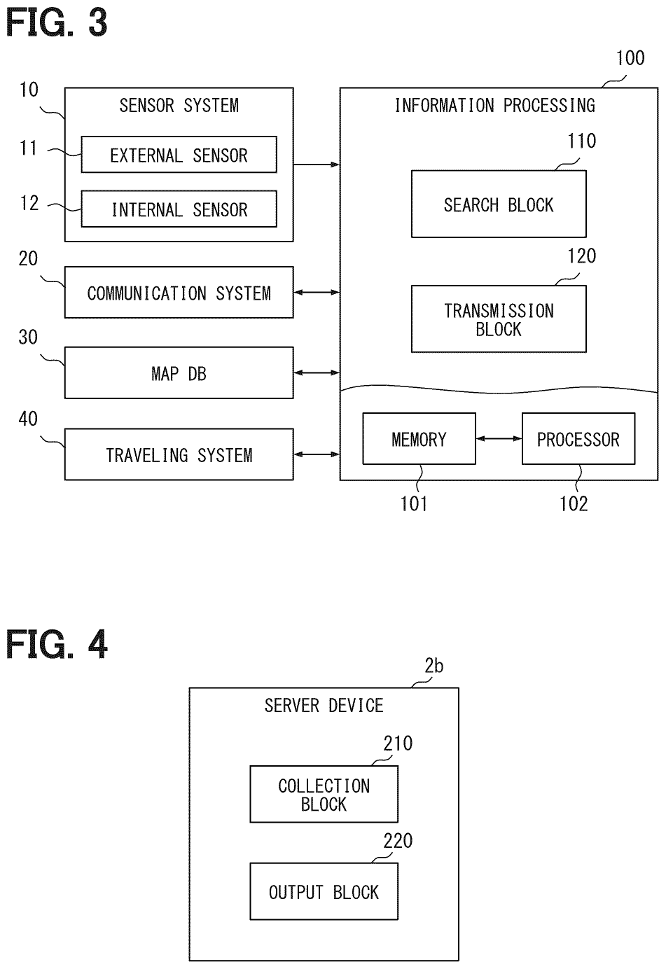

The autonomous traveling device 1 includes a sensor system 10, a communication system 20, a map database 30, a traveling system 40, and an information processing device 100 shown in FIG. 3. The sensor system 10 acquires sensor information that can be used by the information processing device 100, for the external and internal environments of the autonomous traveling device 1. For this acquisition, the sensor system 10 includes an external sensor 11 and an internal sensor 12.

The external sensor 11 acquires external environment information as sensor information from the external environment, which is the environment in a periphery of the autonomous traveling device 1. The external sensor 11 may be of an object detection type, which detects an object existing in the external environment of the autonomous traveling device 1. Such an object detection type external sensor 11 may be at least one of a camera, a Light Detection and Ranging/Laser Imaging Detection and Ranging (i.e., LiDAR), a radar, and a sonar. The external environment information acquired by the external sensor 11 is sequentially stored in a storage medium, such as a memory 101 of the autonomous traveling device 1 or a memory 201 of the server device 2b, in association with position information of an acquired location.

The internal sensor 12 acquires internal information as sensor information from the internal environment, which is the internal environment of the autonomous traveling device 1. The internal sensor 12 may be of a physical quantity detection type which detects a specific physical quantity of motion in the internal environment of the autonomous traveling device 1. Such a physical quantity detection type internal sensor 12 may be at least one of a traveling speed sensor, an acceleration sensor, and a gyro sensor.

The communication system 20 acquires communication information available by the information processing device 100 through wireless communication. The communication system 20 may include a positioning type system that receives positioning signals from an artificial satellite of a global navigation satellite system (GNSS) located outside the autonomous traveling device 1. The positioning type communication system 20 is, for example, a GNSS receiver and the like. The communication system 20 includes a wide area communication type that transmits and receives communication signals to and from a wide area communication system that exists outside of the autonomous traveling device 1. The communication system 20 of the wide area communication type may be at least one of a dedicated short range communications (i.e., DSRC) device, a cellular V2X (i.e., C-V2X) communication device, or the like, for example. With the wide area communication type communication system 20, the autonomous traveling device 1 periodically provides its own position information to the remote center 2. The communication system 20 includes a short range communication type, in which signals are transmitted and received by local communication between autonomous traveling devices 1 that are relatively close to each other. The short range communication type communication system 20 is, for example, at least one of Bluetooth (registered trademark) equipment, Wi-Fi (registered trademark) equipment, infrared communication equipment, and the like.

The map database 30 stores map information that can be used by the information processing device 100. The map database 30 includes at least one non-transitory tangible storage medium, such as a semiconductor memory, a magnetic medium, and an optical medium. The map database 30 may be a database of a locator that estimates self-state quantities including the self-position of the autonomous traveling device 1. The map database 30 may be a database of a planning unit that plans traveling of the autonomous traveling device 1. The map database 30 may be configured by combining various types of these databases.

The map database 30 acquires and stores the latest map information, for example, through communication with the remote center 2 via the communication system 20. The map information is converted into two-dimensional or three-dimensional data as information indicating the traveling environment of the autonomous traveling device 1. Digital data of a high definition map may be adopted as the three-dimensional map data.

The map information may include facility information that represents at least one type of facility, for example, the position, shape, and floor condition of the walls, floors, and the like of the facility where the vehicle or device travels. The map information may include installation object information that represents at least one type of installation object attached to the facility, for example, location, shape, and type. The map information may include road information indicating at least one of a position, a shape and a surface condition of a traveling road. The map information may include marking information, which indicates at least one of traffic sign attached to a road, lane mark position, or lane mark shape, for example. The map information may include, for example, structure information indicating at least one of positions or shapes of a building and a traffic light along a road.

The traveling system 40 controls the traveling of the autonomous traveling device 1 in cooperation with the information processing device 100 and other devices. The traveling system 40 includes, for example, multiple of drive wheels and an electric actuator that controls said drive wheels. The drive wheels are considered to be wheels that are capable of turning movements due to the difference in rotational speed between the drive wheels, such as mecanum wheels and omni wheels, for example. The electric actuator is capable of independently driving and rotating each of the drive wheels. The electric actuator can switch the drive mode of the autonomous traveling device 1 between straight-line drive and turning drive by adjusting the rotational speed difference of the drive wheels. The electric actuator may be equipped with a brake unit that applies braking force to each of the drive wheels while they are rotating. The electric actuator may be provided with a lock unit that locks each of the drive wheels when the wheels are stopped.

The information processing device 100 is connected to the sensor system 10, the communication system 20, and the map database 30 via at least one of a LAN (Local Area Network) line, a wire harness, an internal bus, or a wireless communication line. The information processing device 100 includes at least one dedicated computer.

The dedicated computer constituting the information processing device 100 may be a planning electronic control unit (ECU) that plans a target trajectory for the autonomous traveling device 1. The dedicated computer constituting the information processing device 100 may be a trajectory control ECU that causes the actual trajectory of the autonomous traveling device 1 to follow the target trajectory. The dedicated computer constituting the information processing device 100 may be an actuator ECU that controls the electric actuators and the like of the autonomous traveling device 1.

The dedicated computer constituting the information processing device 100 may be a sensing ECU that controls the sensor system 10 of the autonomous traveling device 1. The dedicated computer constituting the information processing device 100 may be a locator ECU that estimates the self-state quantity of the autonomous traveling device 1. The dedicated computer comprising the information processing device 100 may be a computer other than the autonomous traveling device 1, and the computer, for example, constitutes an external center or mobile terminal that can communicate with the autonomous traveling device 1 via the communication system 20.

The dedicated computer constituting the information processing device 100 includes at least one memory 101 and at least one processor 102. The memory 101 is at least one type of non-transitory tangible storage medium, such as a semiconductor memory, a magnetic medium, and an optical medium, for storing, in non-transitory manner, computer readable programs and data. Here, the storage may refer to storage where data is retained even when the autonomous traveling device 1 is turned off, or it may refer to temporary storage where data is erased when the autonomous traveling device 1 is turned off. The processor 102 includes at least one type of, for example, a CPU (i.e., Central Processing Unit), a GPU (i.e., Graphics Processing Unit), a RISC (i.e., Reduced Instruction Set Computer)-CPU, a DFP (i.e., Data Flow Processor), a GSP (i.e., Graph Streaming Processor), or the like as a core.

In the information processing device 100, the processor 102 executes multiple instructions included in the search program, which are stored in the memory 101 to execute the search control that causes the autonomous traveling device 1 to search the traveling area A where the hazard occurred. In this way, the information processing device 100 constitutes multiple functional blocks for the search control. The multiple functional blocks constructed in the information processing device 100 include a search block 110 and a transmission block 120, as shown in FIG. 3.

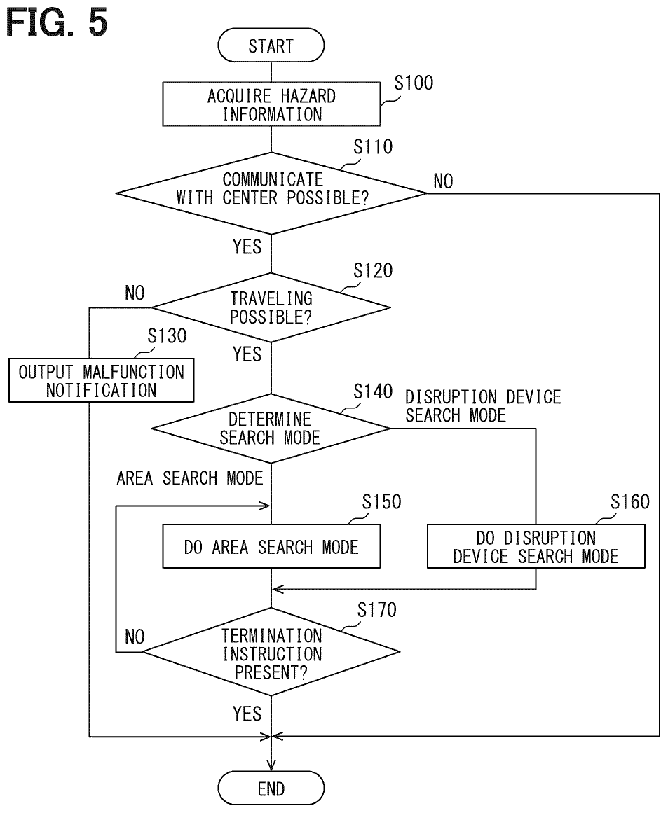

A search control method in which the information processing device 100 performs search control together with these blocks 110, 120 is performed according to a search control flow as shown in FIGS. 5 to 7. This search control flow is repeatedly executed during startup of the autonomous traveling device 1. Each “S” in the search control flow means multiple processes executed by multiple instructions included in a search control program.

First, in S100, the search block 110 acquires hazard information. The hazard information is information indicating the occurrence of a hazard. Therefore, the traveling area A, to which the hazard information corresponds, is the area where the hazard is estimated to occur. The search block 110 acquires the hazard information, for example, from the remote center 2 via the communication system 20. Alternatively, the search block 110 may obtain hazard information by determining the occurrence of a hazard based on the information acquired by its own external and internal sensors 11 and 12.

Next, S110, the search block 110 determines whether communication with the remote center 2 is possible. The search block 110 determines the availability of communication with the remote center 2 by the failure diagnosis of the wide area communication type communication system 20 and by attempting to communicate with the remote center 2. When it is determined that communication is not possible, this flow ends. In this case, the autonomous traveling device 1, which is an autonomous traveling device 1 in a disruption state, waits for a search from the autonomous traveling device 1, which is in an active state that can communicate with the remote center 2 described later. In the following, the autonomous traveling device 1 in the disruption state may be referred to as a disruption device. The autonomous traveling device 1 in the active state may also be referred to as an active device. In addition, when the short range communication type communication system 20 is available, the disruption device may transmit signals to the peripheral area via short range communication to assist in the search by the active device.

On the other hand, when it is determined in S110 that communication with remote center 2 is possible, this flow proceeds to S120. In S120, the search block 110 determines whether the autonomous traveling device 1 is possible to travel. The search block 110 may determine whether the vehicle is possible to travel by, for example, performing the failure diagnosis on the sensor system 10 and the traveling system 40. When it is determined that the vehicle is not possible to travel, the flow proceeds to S130. In S130, the transmission block 120 transmits the failure notification indicating that the traveling is not possible to the remote center 2 via the communication system 20, and then ends this flow. Even when it is determined that the traveling is not possible, the autonomous traveling device 1 may transmit observation information (described later) in the periphery of a current stop position to the remote center 2, as long as the external sensor 11 is available.

On the other hand, when it is determined in S120 that the traveling is possible, this flow proceeds to S140. In S140, the search block 110 determines the search mode of the autonomous traveling device 1. For example, the search block 110 determines the search mode by obtaining an instruction from the remote center 2 to specify the mode. The search mode includes, for example, an area search mode and a disruption device search mode. When the mode is determined to be the area search mode, this flow shifts to S150. When the mode is determined to be the disruption device search mode, this flow shifts to S160.

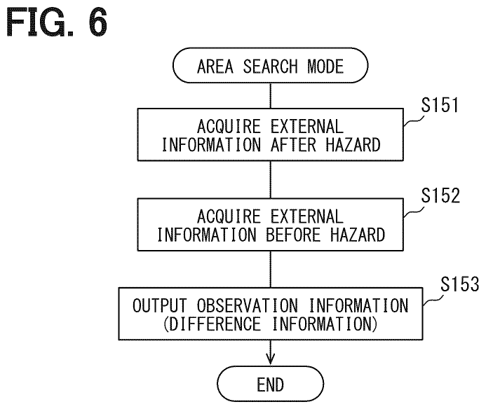

In executing the area search mode in S150, the autonomous traveling device 1 searches for facilities that constitute the traveling area A and transmits the search results to the remote center 2. The detailed processing in S150 is described below according to the flowchart in FIG. 6.

In S151, the search block 110 acquires external environment information of the traveling area A after the hazard. In detail, the search block 110 causes the autonomous traveling device 1 in the vicinity of a location in the traveling area A for which observation information described later has not yet been acquired, and acquires the external environment information of the location from the external sensor 11. In this case, the search block 110 may, for example, cause the vehicle to follow the location from which the external environment information was acquired before the hazard occurs. Alternatively, the search block 110 may cause the vehicle to continue traveling on the traveling plan route before the hazard occurs. Alternatively, the search block 110 may cause the vehicle to travel along the traveling plan route that is delivered from the remote center 2 after the hazard. The search block 110 acquires the external environment information in association with position information of the location.

In the following S152, the search block 110 acquires pre-hazard external environment information related to the location for which the external environment information was acquired in S151. The search block 110 acquires the pre-hazard external environment information by reading, from the storage medium, the pre-hazard external environment information that substantially matches the external environment information and position information acquired in S151. The pre-hazard external environment information may have been acquired by another autonomous traveling device 1.

Furthermore, in S153, the transmission block 120 outputs observation information to the remote center 2 according to the external environment information before and after the hazard. In detail, the transmission block 120 outputs the difference information between the external environment information acquired in the area search and the external environment information before the hazard as observation information. The observation information may also include the results of analysis of such differences. The output observation information is transmitted to the remote center 2 via the communication system 20. After the process of S153, the flow proceeds to S170 in FIG. 5.

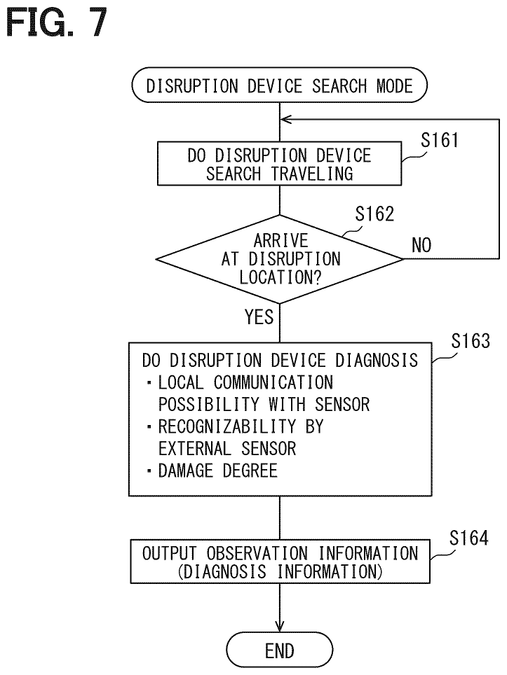

On the other hand, in the execution of the disruption device search mode in S160, the autonomous traveling device 1 searches for disruption devices and transmits the search results to the remote center 2. The detailed process in S160 will be described with reference to the flowchart of FIG. 7.

In S161, the search block 110 starts disruption device search traveling. In the disruption device search traveling, the search block 110 acquires position information on the disruption device immediately before the disruption from the remote center 2 or the like, and controls the traveling system 40 toward the disruption location where the disruption device is estimated to exist. The disruption location is, for example, a defined range area that includes the position coordinates immediately before the disruption.

In the following S162, the search block 110 determines whether the autonomous traveling device 1 has arrived at the disruption location. The search block 110 continues the disruption device search traveling until a determination is made to arrive at the disruption location. When it is determined that the autonomous traveling device has reached the disruption location, this flow shifts to S163.

In S163, the search block 110 executes a diagnosis process regarding the state of the disruption device at the disruption location. In the diagnosis process, the search block 110 determines the availability of local communication between the active device (own device) and the disruption device, for example, by the short range communication type communication system 20. In addition, in the diagnosis process, the search block 110 determines whether the disruption device can be recognized by its own external sensor 11. Furthermore, in the diagnosis process, when the search block 110 can recognize the disruption device, it determines the degree of damage with respect to the appearance of the disruption device.

Then, in S164, the transmission block 120 outputs the diagnosis information of the disruption device acquired in S163 as the observation information. The output observation information is transmitted to the remote center 2 via the communication system 20. After the process of S164, the flow proceeds to S170 in FIG. 5.

In S170, the search block 110 determines whether there is an instruction to end the search. The end instruction is transmitted to the autonomous traveling device 1 in response to an operation by an operator or other manager at the remote center 2, for example. When there is no end instruction, the search block 110 executes the area search mode in S150. In other words, the autonomous traveling device 1 that performs the area search mode expands the area search area in the facility until the end instruction is given. When the autonomous traveling device 1 that performs the disruption device search mode does not receive an end instruction after searching for the disruption device, the autonomous traveling device 1 shifts to the area search mode. As a result, the percentage of autonomous traveling devices 1 that execute the area search mode in the active state increases over time. When the end instruction is acquired, this flow ends and the search process is completed. After ending the search, the autonomous traveling device 1 may wait at the search end point, or may leave the traveling area A in response to evacuation information from the remote center 2.

Next, the details of server device 2b in remote center 2 will be described. the server device 2b generates evacuation information in response to the search process of autonomous traveling device 1 described above. The server device 2b is connected to a communicator 2a that communicates with the autonomous traveling device 1 via at least one of, for example, a LAN line, a wire harness, an internal bus, or a wireless communication line. The server device 2b includes at least one dedicated computer.

The dedicated computer constituting the server device 2b includes at least one memory 201 and at least one processor 202. The memory 201 is at least one type of non-transitory tangible storage medium, such as a semiconductor memory, a magnetic medium, or an optical medium, that non-temporarily stores computer-readable programs and data. Here, storage may refer to accumulation in which data is retained even when the dedicated computer is turned off, or may refer to temporary storage in which data is erased when the dedicated computer is turned off. The processor 202 includes, for example, at least one type of core, such as a CPU, a GPU, a RISC-CPU, a DFP, or a GSP.

In the server device 2b, the processor 202 executes multiple instructions included in the evacuation information generation program stored in the memory 201 to generate evacuation information in the traveling area A of autonomous traveling device 1. Thereby, the server device 2b constructs several functional blocks for generating evacuation information in the traveling area A. The multiple functional blocks constructed in the evacuation information generation system 3 include a collection block 210 and an output block 220 as shown in FIG. 4.

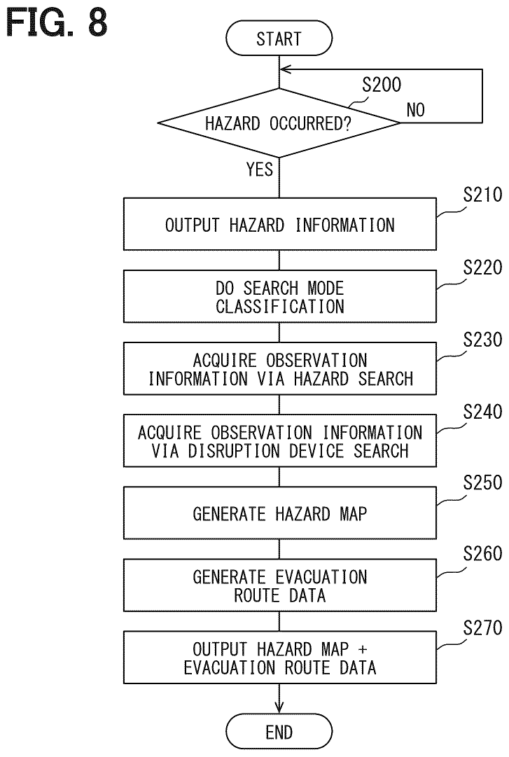

The evacuation information generation method in which the server device 2b generates evacuation information of the traveling area A of the autonomous traveling device 1 by cooperation of these blocks 210 and 220 is executed according to the evacuation information generation flow shown in FIG. 8. This evacuation information generation flow is repeated during startup of the dedicated computer. Each “S” in the evacuation information generation flow means multiple processes executed by multiple instructions included in an evacuation information generation program.

First, in S200, the collection block 210 determines whether the hazard occurs. The collection block 210 may determine that the hazard has occurred when hazard occurrence information is acquired from at least one of, for example, distribution from a public communication network such as the Internet, a report from a facility, and information provided by a fire department or the like. The collection block 210 waits for this flow to proceed until a determination is made that an event has occurred. When the hazard is determined to have occurred, this flow proceeds to S210. In S210, the output block 220 outputs the hazard information to the autonomous traveling device 1. The hazard information is transmitted to each autonomous traveling device 1 in the traveling area A via the communicator 2a.

Next, in S220, the collection block 210 performs search mode classification for the autonomous traveling device 1 in the traveling area A. Specifically, the collection block 210 communicates with the autonomous traveling device 1 to identify active device that provides no malfunction notification, i.e., autonomous traveling devices 1 that are capable of traveling. The collection block 210 then classifies the identified autonomous traveling devices 1 into devices that perform the area search mode and devices that perform the disruption device search mode. The collection block 210 can, for example, assign the disruption device search mode to the autonomous traveling device 1 closest to each disruption location and the other autonomous traveling devices 1 to the area search mode. Note that the collection block 210 may assign multiple autonomous traveling devices 1 to a single disruption location. The collection block 210 outputs the classification results to each autonomous traveling device 1 to execute the corresponding search mode for each autonomous traveling device 1.

In the following S230, the collection block 210 acquires observation information from each autonomous traveling device 1 in the active state by the area search. Then, in S240, the collection block 210 acquires observation information from each autonomous traveling device 1 in the active state by the disruption device search. The processes of S230 and S240 may be executed in parallel. The collection block 210 continues the acquisition process until enough location observation information has been collected for hazard map generation, then the process shifts to S250.

In S250, the output block 220 generates the hazard maps for each observation information. Here, the hazard map is evacuation information in map format that represents the hazard level for each location in the traveling area A. The hazard level is the degree of danger to the user in the traveling area A. The user is, for example, a person. Alternatively, the user may be the autonomous traveling device 1. The output block 220 may estimate the hazard level for each type of user.

The output block 220 estimates the hazard level for the corresponding location from each observation information. For example, as shown in FIG. 11, the output block 220 estimates the hazard level for each location as a parcel that divides the traveling area A according to the observation information at the corresponding location.

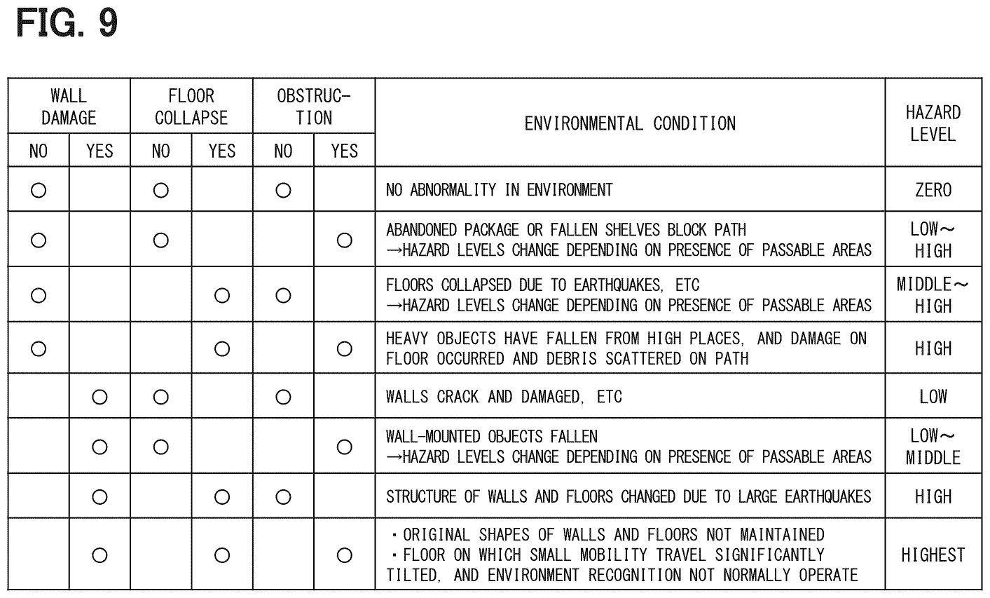

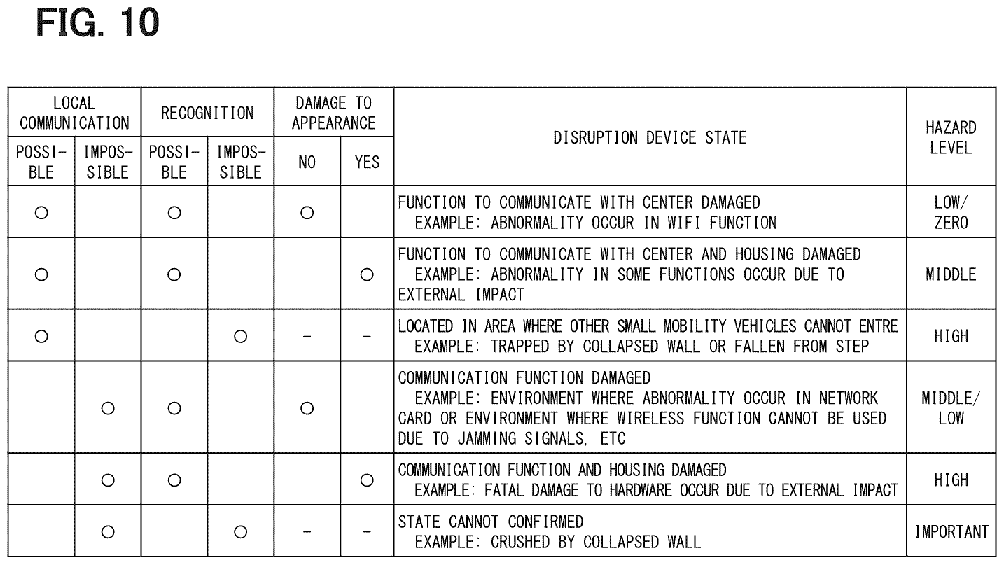

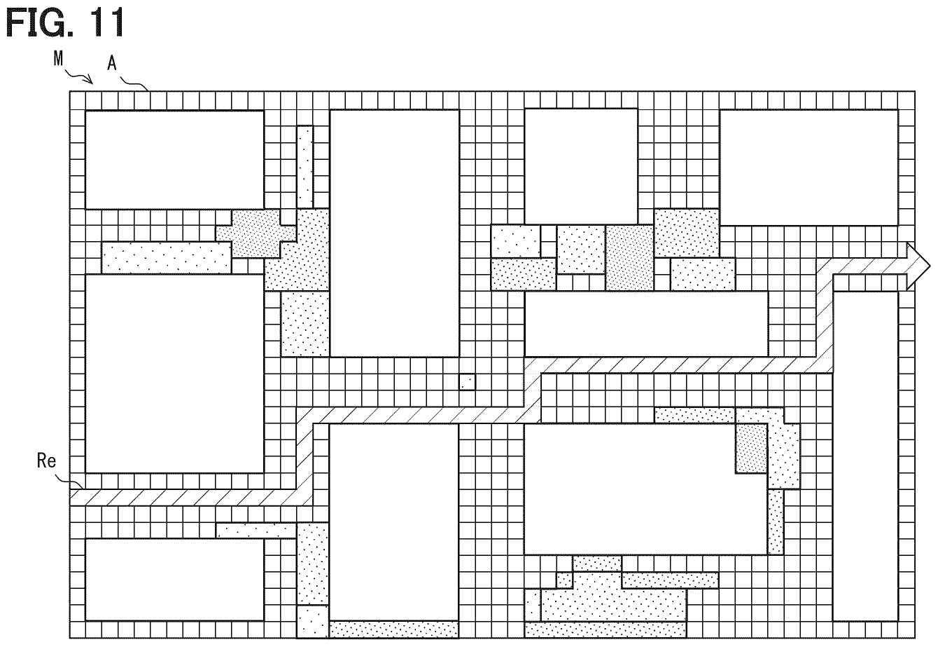

The output block 220 sets multiple hazard levels according to the information from the observation information, as shown in FIGS. 9 and 10. In the example shown in FIGS. 9 and 10, the output block 220 sets the five hazard levels from lowest to highest: zero, low, meddle, high, and highest. In the following examples, the magnitude of the hazard level is assumed to be the same for both the person and the autonomous traveling device 1, unless otherwise specified.

For example, as shown in FIG. 9, the output block 220 determines the presence or absence of damage to nearby walls, sinking of floors, and obstructions on floors for each location based on the observation information from area search, and determines the hazard level based on the location state estimated from the determination results.

Specifically, when the output block 220 determines that there is no damage to the wall, no sinking of the floor, and no obstructions, it estimates that the location has no abnormality. In this case, the output block 220 determines the hazard level to be zero. When the output block 220 determines that there is the obstruction without damage to the walls and sinking of the floor, it also determines the hazard level between low and high at the location. The output block 220 determines the larger the hazard level for the area and obstruction position the smaller the passable area is due to the obstacle. The output block 220 may determine the obstruction position and the hazard level of the passable area separately.

Furthermore, when the output block 220 determines that there is no damage to the wall, the floor is sunken, and there are no obstructions, it estimates that the floor is missing at that location. In this case, the output block 220 determines the hazard level between medium and high. The output block 220 determines that the area and the sunken portion are assigned a higher hazard level as the passable area becomes smaller due to the sinking of the floor. The output block 220 may determine the hazard level of the sunken portion and the passable area separately.

When the output block 220 determines that there is no damage to the wall, the floor is sunken, and there is the obstruction, it is presumed that the floor has been damaged by the fall of a heavy object at the location and that the heavy object or its debris is scattered on the floor. In this case, the output block 220 determines the hazard level to be high. Furthermore, when the output block 220 determines that there is damage to the walls, no sinking of the floor, and no obstructions, it determines the hazard level to be low at that location.

When the output block 220 determines that there is damage to the wall, no sinking of the floor, and the obstruction, it estimates that the object placed on the wall has fallen to the floor at that location. In this case, the output block 220 determines the hazard level from low to medium. The output block 220 determines the larger the hazard level for the area and the falling object position the smaller the passable area is due to the falling object. The output block 220 may determine the hazard level of the position of the falling object and the passable area separately.

Furthermore, when the output block 220 determines that there is damage to the walls, sinking of the floor, and no obstruction, it estimates that the structure of the walls and floor has been changed by the hazard. In this case, the output block 220 determines the hazard level to be high. When the output block 220 determines that there is damage to the wall, sinking of the floor, or the obstruction, it estimates that the wall or floor is not keeping its shape due to the hazard, or that the floor is so deformed that environmental recognition is not normally performed. In this case, the output block 220 determines the highest hazard level.

The output block 220 also determines the state of the disruption device from the observation information by the disruption device search, as shown in FIG. 10. For example, the output block 220 determines local communication availability for the disruption device, whether the disruption device has been found, and whether the appearance of the disruption device is damaged. The output block 220 determines the hazard level at the disruption location based on the state of the disruption device as estimated from the determination results.

Specifically, when the output block 220 determines that local communication is possible, that the device has been found, and that there is no external appearance damage, it determines that only the communication function of the disruption device with the center is damaged. In this case, the output block 220 determines the hazard level for persons to be zero. In this case, the output block 220 also sets the hazard level to the low level for the autonomous traveling device 1. Furthermore, when the output block 220 determines that local communication is possible, that the device has been found, and that there is external appearance damage, it estimates that the communication function with the center and the housing of the disruption device has been damaged by an external impact. In this case, the output block 220 determines the hazard level to be medium.

Further, when the output block 220 determines that local communication is possible, the device has not been found, and it is not possible to determine whether the external appearance of the device is damaged, it estimates that the disruption device has been left behind in an area where other autonomous traveling devices 1 cannot enter. In this case, the output block 220 determines the hazard level to be high.

Furthermore, when the output block 220 determines that local communication is not possible, that the device has been found, and that there is no external appearance damage, it estimates that the communication function is not available due to an abnormality in the network card, generation of jamming radio waves, or the like. In this case, the output block 220 determines the hazard level for persons to be low. In this case, the output block 220 also determines the hazard level for autonomous traveling device 1 to be the middle level.

Furthermore, when the output block 220 determines that local communication is not possible, that the device has been found, and that there is damage to the external appearance, it estimates that serious damage has occurred to the hardware of the disruption device due to an external impact. In this case, the output block 220 determines the hazard level to be high. When the output block 220 determines that local communication is not possible and the device has not been found and it is not possible to determine whether there is any external damage, it estimates that the state of the disruption device cannot be confirmed because the device has been embroiled in the collapse of a facility, for example. In this case, the output block 220 determines the hazard level to be the highest.

By setting the hazard levels for each location as described above, the output block 220 generates a hazard map M, as shown in FIG. 11, with hazard levels specified for each parcel. In FIG. 11, the higher the density of the dot hatching, the higher the hazard level. A parcel without hatching is a location with the hazard level set to zero.

In the following S260, the output block 220 generates evacuation route data within the traveling area A. The evacuation route data is evacuation information in map format that represents the evacuation route Re within the traveling area A. The output block 220 generates evacuation route data based on the hazard map M generated in S250.

Specifically, the output block 220 searches for the route with the lowest hazard cost from the specified starting point to the exit of traveling area A, and designates the route as an evacuation route Re. For example, when an evacuee is detected within the traveling area A, the starting point of the evacuation route Re is the current position of the evacuee. Alternatively, the evacuation route Re may start at any position. For example, the starting point of the hazard cost is the cost according to the hazard level in the hazard map M. The hazard cost is a parameter related to the sum of the hazard levels of each location passed through, and quantified so that the higher the level, the larger the value. In the example shown in FIG. 11, the evacuation route Re with the lowest hazard level (zero) is shown, but it may pass through locations with hazard levels greater than zero when the hazard cost is minimized. In addition, the output block 220 may generate evacuation route data with the constraint that the route does not pass through locations with a specified hazard level or more regardless of hazard cost.

Then, in S270, the output block 220 outputs the hazard map M and evacuation route data. The output block 220 may output the evacuation information to rescue organizations, such as fire departments, for example. Alternatively, the output block 220 may output the evacuation information to the autonomous traveling device 1 in the traveling area A. Alternatively, the output block 220 may output the evacuation information to operators and other personnel at the remote center 2.

At this time, the output block 220 outputs the evacuation route data in association with the hazard map M. That is, the output block 220 performs the association so that the position of the evacuation route Re is presented on the hazard map M, as shown in FIG. 11.

According to the first embodiment described above, the hazard map M is output according to observation information obtained by the autonomous traveling device regarding the traveling area A where the occurrence of a hazard is estimated. Therefore, the hazard map M for each location can reflect the actual observation information related to the location. Accordingly, it is possible to generate valid evacuation information.

Further, according to the first embodiment, the route evacuation data is output according to observation information obtained by the autonomous traveling device regarding the traveling area A where the occurrence of a hazard is estimated. Therefore, it is possible to reflect the actual observation information in the evacuation route data within the traveling area A. Accordingly, it is possible to generate valid evacuation information.

Furthermore, according to the first embodiment, evacuation route data is output in association with the hazard map M. Therefore, it is possible to provide highly convenient evacuation information that allows users to grasp both hazard levels and evacuation route data.

In addition, according to the first embodiment, acquiring observation information includes acquiring observation information obtained by searching the traveling area A using the active device among the multiple autonomous traveling devices 1 capable of communicating with the outside. Therefore, it is possible to generate the evacuation information utilizing active devices that can communicate with the outside.

Furthermore, according to the first embodiment, acquiring the observation information includes acquiring the observation information by searching for the facilities that constitute the traveling area A by the active device. Thereby, it is possible to generate evacuation information according to damage to the traveling area A due to the hazard.

Furthermore, according to the first embodiment, acquisition of observation information includes acquisition of observation information of the disruption device among multiple autonomous traveling devices 1. The disruption device has lost communication with the outside in the traveling area A, and the observation information is obtained by the search of an active device. The output of the evacuation information includes output of the hazard map M showing the hazard level of the location where the presence of the disruption device is estimated, as the hazard level according to the state of the detected disruption device. Therefore, by utilizing the active device, it is possible to generate the evacuation information according to the state of the disruption device.

In addition, according to the first embodiment, the outputting the evacuation information includes outputting the hazard map M that represents the hazard level according to the state of intercommunication between the active device and the disruption device. Therefore, it is possible to generate the evacuation information utilizing the state of mutual communication between the active device and the disruption device.

Furthermore, according to the first embodiment, outputting the evacuation information includes outputting the hazard map M showing a hazard level according to the observation state of the disruption device by the active device. According to this, it is possible to generate the evacuation information according to the observation state of the disruption device by utilizing the active device.

### Other Embodiments

Although one embodiment has been described above, the present disclosure is not to be construed as being limited to the embodiment of the description, and can be applied to various embodiments within the scope not departing from the gist of the present disclosure.

In a modification, some of the functions executed by the server device 2b may be executed by another control device, such as the information processing device 100 of the autonomous traveling device 1. In addition, in the modification, some of the functions executed by the information processing device 100 may be executed outside the autonomous traveling device 1, such as at the remote center 2.

In the modification, the evacuation information generation system 3 may output only one of the hazard map M and the evacuation route data.

In the modification, a dedicated computer constituting the evacuation information generation system 3 may include at least one of a digital circuit or an analog circuit, as a processor. The digital circuit is at least one type of, for example, an application specific integrated circuit (i.e., ASIC), an environment programmable gate array (i.e., FPGA), a system on a chip (i.e., SOC), a programmable gate array (i.e., PGA), a complex programmable logic device (i.e., CPLD), and the like. Such a digital circuit may also include a memory in which a program is stored.

In addition to the descriptions so far, the above-described embodiment and modification may be implemented as an evacuation information generation device mountable on the autonomous traveling device 1 or the remote center 2 and has at least one processor and at least one memory. In this case, the evacuation information generation device may be implemented in the form of a processing circuit (for example, a processing ECU, etc.) or a semiconductor device (for example, a semiconductor chip, and the like).

What is claimed is:

1. An evacuation information generation system for generating evacuation information of a traveling area for an autonomous traveling device, the system comprising
a processor;
a memory coupled to the processor and storing program instructions that when executed by the processor cause the processor to at least:
acquire observation information obtained by observation by the autonomous traveling device that searches for the traveling area where a hazard is estimated to occur; and
output the evacuation information according to the observation information.

2. The evacuation information generation system according to claim 1, wherein
the processor is further configured to output the evacuation information as a hazard map that represents a hazard level for each location in the traveling area.

3. The evacuation information generation system according to claim 2, wherein
the processor is further configured to output the evacuation information as evacuation route data within the traveling area based on the hazard map.

4. The evacuation information generation system according to claim 3, wherein
the processor is further configured to output the evacuation information as evacuation route data in association with the hazard map.

5. The evacuation information generation system according to claim 1, wherein
the processor is further configured to output the evacuation information as evacuation route data within the traveling area.

6. The evacuation information generation system according to claim 2, wherein
autonomous traveling device includes a plurality of autonomous traveling devices, and
processor is further configured to acquire the observation information by searching for the traveling area using an active device capable of communicating with an outside among the plurality of autonomous traveling devices.

7. The evacuation information generation system according to claim 6, wherein
the processor is further configured to acquire the observation information obtained by the active device that searches for a facility that constitutes the traveling area.

8. The evacuation information generation system according to claim 6, wherein
the processor is further configured to
acquire the observation information obtained by the active device that searches for a disruption device that has lost communication with the outside within the traveling area among the plurality of autonomous traveling devices, and
output the evacuation information as a hazard map representing a hazard level of a location where an existence of the disruption device is estimated as a hazard level according to a state of the searched disruption device.

9. The evacuation information generation system according to claim 8, wherein
the active device is the autonomous traveling device capable of communicating with a remote center,
the disruption device is the autonomous traveling device having lost communication with the remote center, and
the processor is further configured to output the evacuation information as the hazard map representing the hazard level according to a state of mutual communication between the active device and the disruption device.

10. The evacuation information generation system according to claim 8, wherein
the evacuation information includes the hazard map representing the hazard level according to an observation state of the disruption device by the active device.

11. An evacuation information generation device installable in an autonomous traveling device or a remote center and used for generating evacuation information of a traveling area of the autonomous traveling device, the device comprising
a processor;
a memory coupled to the processor and storing program instructions that when executed by the processor cause the processor to at least:
acquire observation information obtained by observation by the autonomous traveling device that searches for the traveling area where a hazard is estimated to occur; and
output the evacuation information according to the observation information.

12. The evacuation information generation device according to claim 11, wherein
the processor is further configured to output the evacuation information as a hazard map representing a hazard level for each location within the traveling area according to the observation information.

13. The evacuation information generation device according to claim 11, wherein
the processor is further configured to output the evacuation information as evacuation route data within the traveling area.

14. An autonomous traveling device autonomously traveling in a traveling area, the device comprising
a processor;
a memory coupled to the processor and storing program instructions that when executed by the processor cause the processor to at least:
acquire observation information obtained by observation by the autonomous traveling device that searches for the traveling area where a hazard is estimated to occur; and
output evacuation information according to the observation information.

15. The autonomous traveling device according to claim 14, wherein
the processor is further configured to output the evacuation information as a hazard map representing a hazard level for each location within the traveling area.

16. The autonomous traveling device according to claim 14, wherein
the processor is further configured to output the evacuation information as evacuation route data within the traveling area.

17. An evacuation information generation method executed by a processor for generating evacuation information of a traveling area for an autonomous traveling device, the method comprising:
acquiring observation information obtained by observation by the autonomous traveling device that searches for the traveling area where a hazard is estimated to occur; and
outputting the evacuation information according to the observation information.

18. The evacuation information generation method according to claim 17, wherein
outputting the evacuation information includes outputting the evacuation information as a hazard map representing a hazard level for each location within the traveling area.

19. The evacuation information generation method according to claim 17, wherein
outputting the evacuation information includes outputting the evacuation information as evacuation route data within the traveling area.
